(19) United States
(12) Patent Application Publication
(10) Pub. No.: US 2008/0074233 A1
(43) Pub. Date: Mar. 27, 2008

(54) Active sensor and actuation system

(76) Inventor: Thomas Weingartner, Untereuerheim (DE)

Correspondence Address: WHITE & CASE LLP;PATENT DEPARTMENT, 1155 AVENUE OF THE AMERICAS, NEW YORK, NY, 10036, US

(21) Appl. No.: 11/672,685

(22) Filed: Feb. 8, 2007

(30) Foreign Application Priority Data
Sep. 22, 2006 (DE) 20 2006 002 044.6

(51) Int. Cl. G05B 23/02

(52) U.S. Cl. 340/3.1

(57) ABSTRACT

An active sensor having a transmitter for emitting a measurement signal, having a receiver for receiving the measurement signal, having a transmission link for transmitting the measurement signal, and having an evaluation unit which is configured to register a change in the transmission characteristic of the measurement signal and to generate an output signal, which corresponds to the registered change, the transmitter being configured to emit the measurement signal discontinuously, the transmission power being briefly above a maximum transmission power that is possible during continuous operation and being on average below the maximum transmission power

### FIELD OF THE INVENTION

The invention relates to an active sensor having a transmitter for emitting a measurement signal, having a receiver for receiving the measurement signal and having a transmission link for transmitting the measurement signal. The invention also relates to an actuation system having such a sensor.

### BACKGROUND OF THE INVENTION

Generally, a sensor converts a variable to be measured, for example a physical variable such as temperature or pressure, in such a way that it can be further processed electronically. Electronic processing has various advantages. A high level of sensitivity is achieved through signal amplification and filtering. The measured values can be stored so that more extensive analyses such as statistical analyses or frequency analyses can be carried out.

An active sensor is to be understood as being a sensor that has to be supplied with electrical energy in order to generate a measurement signal. A known example of an active sensor is a Hall sensor that converts a change in a magnetic field into a proportional electrical output variable. A voltage has to be applied for this purpose.

An active sensor of the type mentioned above has a transmitter and a receiver. In such a case, the transmitter generates a measurement signal that is received by the receiver. In order to transmit the measurement signal, a solid, liquid, or gaseous medium is used. The transmitter and receiver are coupled to this medium and are connected to one another via this medium. Changes in the medium and, if appropriate, the cause(s) of the changes, can be determined on the basis of changes in the transmission characteristic of the measurement signal between the transmitter and receiver.

This measurement principle is used in particular in tactile sensors that register a pressure or contact. The registration takes place capacitively, electrically, or by means of the attenuation of light or surface waves.

A tactile sensor that detects the attenuation of light due to pressure or contact is known from U.S. Pat. No. 6,144,790. Here, light is radiated through an optical waveguide with a pressure-sensitive jacket. A pressure applied to this jacket causes the light to be attenuated and this attenuation is detected by a receiver.

A further tactile sensor emits surface waves with a transmitter, changes in which can be detected by a receiver. In this context, the transmitter and receiver are coupled via a solid body. A change in the oscillatory behavior of the solid body, which can be caused, for example, by attenuation of its oscillation, such as can be caused by contact with an object, changes the transmission characteristic and can thus be detected.

Tactile sensors are used in particular in automobile engineering. In said context, electric actuation elements such as electric window lifters or electric sliding doors have become standard equipment. Closing such an electric actuation element entails the risk of a body part of a human or of an animal being trapped during the closing process. Such a case of trapping can be detected by means of tactile sensors which are arranged, for example, in the window seal or door seal, and it is possible to take appropriate countermeasures such as stopping the movement of the actuation element or carrying out an opposing movement in the opening direction counter to the closing direction, in order to release the trapped object again.

A limiting factor with a sensor of the type mentioned above is the maximum range of the transmitter and thus the maximum distance between the transmitter and receiver. Although this maximum distance can be increased by raising the transmission power, raising the transmission power also increases the power loss of the transmitter, which leads to greater heating of its components. This heating can cause the components, and thus the transmitter, to be destroyed. The transmission power of the transmitter can disadvantageously only be raised by correspondingly dimensioning the components, which entails additional costs.

### SUMMARY OF THE INVENTION

The invention is based on the object of specifying a sensor of the type mentioned above which has the greatest possible range. A further object is to specify an actuation system which is as reliable as possible for detecting a case of trapping.

According to the invention, the first-mentioned object is achieved by means of a sensor, the transmitter of which is configured to emit a discontinuous measurement signal. In this context, the transmission power of the transmitter is briefly above a maximum power loss and on average below the maximum power loss.

For this purpose, the active sensor has a transmitter for emitting a measurement signal. This measurement signal is transmitted on a transmission link to the receiver which is designed to receive the measurement signal. An evaluation unit which is connected downstream of the receiver registers a change in the transmission characteristic of the measurement signal and generates an output signal which corresponds to the registered change.

The transmitter is configured to emit the measurement signal discontinuously in such a way that the transmission power is briefly above a maximum transmission power which is possible during continuous operation. Since the transmission power of individual pulses is increased, the possible transmission link between the transmitter and receiver is increased. The measurement signal can thus also be detected by the receiver even after transmission links which would not be possible with comparable sensors from the prior art. During the brief time period of increased transmission power, the components of the transmitter and of the receiver are loaded thermally. However, since the transmission power is very low or equal to zero after this time period, the components of the transmitter and receiver may cool again so that overall damage is avoided and their function is maintained.

In this way, reliable transmission of the measurement signal over a relatively large distance between the transmitter and receiver can be achieved without using expensive, correspondingly dimensioned components. This either makes it possible for measurement tasks in which an extended measured distance is to be covered to be carried out, or else the measurement can be carried out more cost-effectively by using a smaller number of sensors.

Given a predefined transmission link, it is optionally also possible to use a sensor which is smaller in size than conventional sensors, which makes the fabrication process of these sensors more cost-effective.

Because the active sensor has to be provided with an electrical supply, if the transmission power is reduced on average the consumption of electrical energy is also lower than in conventional sensors. In particular in the case of sensors that are battery operated, the intervals between battery changes can also be reduced, lowering costs.

The transmission link for attenuating the measurement signal is expediently embodied as a function of the event to be measured. As a result, components that are matched precisely to the measurement task are used, which contributes to lowering costs for the fabrication of the sensors. For example, a pressure sensor can have an elastic material along the measured distance, the changing shape of which material influences the transmission characteristic of the measurement signal.

In one preferred variant, the active sensor is a tactile sensor with which contact can be detected. A tactile sensor can be embodied, in particular, with a hose-shaped measured distance along which the measurement signal runs. As a result, it is suitable in particular in automobile engineering as a sensor for detecting a case of trapping with an actuation element such as electrically operated windows or doors. A hose-shaped tactile sensor can additionally easily be placed along contours of the vehicle body.

The transmitter expediently emits measurement signals periodically at fixed intervals. In this way it is possible, by selecting the period and transmission power, to define an operating mode of the transmitter such that a defined cooling of the transmitter is ensured during two transmission pulses.

In one expedient variant, the evaluation unit generates a measurement signal only when a change in a measured value is above a predefined threshold. In this way it is possible to reduce thermal loading of components of the evaluation unit.

The transmitter advantageously transmits measurement signals only on request by the receiver. This additionally reduces thermal loading on the individual assemblies of the transmitter and receiver.

According to one expedient development, the transmitter is configured for generating a plurality of different signals simultaneously or successively in a predefined time window. Different information can thus be transmitted.

In a further variant, the sensor comprises a plurality of transmitters to which a common receiver is assigned. In this way it is possible to implement the registration of a plurality of measurement signals more cost-effectively.

If the receiver is additionally configured to differentiate the measurement signals on the basis of their transmission characteristic, in each case a number of measurement signals can be registered by a number of transmitters and assigned, in a uniquely defined fashion, to the individual transmitters. Location-dependent registration of changes in state can thus be implemented, for example.

The second-mentioned object is achieved according to the invention by means of an actuation system having an active sensor as described above. In this context, an actuator element is moved against a stop by means of a drive. This drive is controlled by a control unit. The sensor is connected to the control unit and is used to detect a case of trapping. If a case of trapping is detected by the control unit, the control unit stops the drive and if appropriate reverses it in order to release a trapped object again or to avoid damage through further movement. The stop can be implemented here by means of hardware or by means of software.

A tactile sensor which is arranged on the actuator element or its stop is preferably applied as the sensor. The tactile sensor is usually arranged in the seal of an electrically adjustable window or an electrically adjustable door. As a result of a detected case of trapping, the closing mechanism of the window or of the door is stopped and, if appropriate, the object is released again by reversing the drive.

A great advantage of the specified actuation system with such a sensor is that the measured distance to be monitored by the sensor can be significantly longer compared to sensors of the known type. In particular in the case of an actuator element in automobile engineering, the distance to be monitored for a case of trapping can easily reach a length of several meters. The use of a sensor as described above provides a cost advantage because, if appropriate, only one sensor has to be used. In this way, costs incurred in the manufacture of an actuation system can be lowered, which is advantageous in particular in the automobile industry.

### BRIEF DESCRIPTION OF THE DRAWINGS

FIG. 1 shows a car door with an active sensor in accordance with an embodiment of the systems of the present invention.

FIG. 2 shows a car door with an sensor in accordance with a further embodiment of the systems of the present invention.

### DETAILED DESCRIPTION

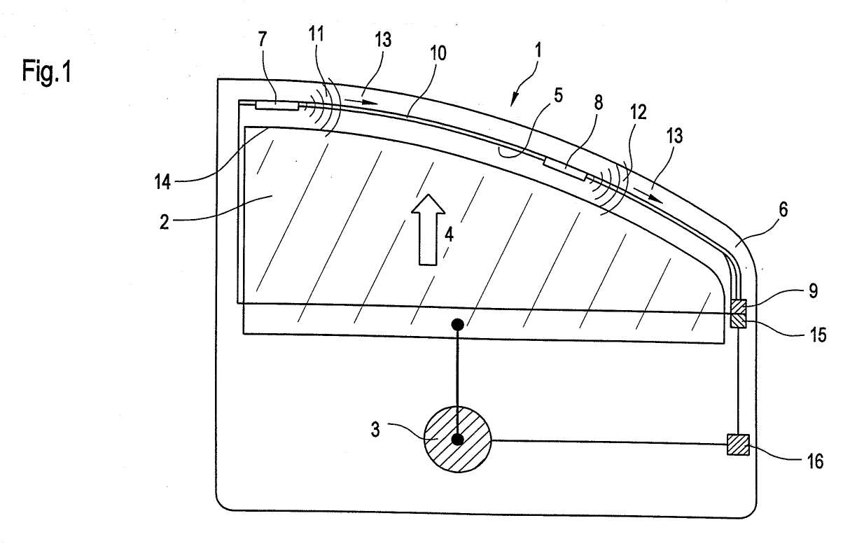

FIG. 1 illustrates a car door 1 into which an actuation unit 2, in this case an electrically liftable window pane, is integrated. The device for actuating the window pane is per se prior art and is merely indicated in the figure. The lifting force which is necessary for the actuation process is made available by an actuator drive 3. During a closing process, the window pane is moved upward in the closing direction 4 until it bears against a stop 5, formed by the essentially horizontally extending upper part of the window frame 6 which is located in the closing direction 4. During an opening process, the window pane is moved by the actuator drive 3 in the opposite direction to the closing direction 4 until the window pane is completely lowered into the car door 1.

In order to detect a case of trapping, an active sensor is provided. Its two transmitters 7, 8 are arranged on the upper part of the window frame 6 located in the closing direction. The two transmitters 7, 8 and the receiver 9 are connected to one another by means of a sheet metal strip 10 and together they form an oscillation system. The sheet metal strip 10 is integrated into the seal of the window frame, extends essentially parallel to the stop 5 and is decoupled in terms of oscillation technology from the window frame 6. The seal is not illustrated in FIG. 1 for reasons of clarity.

The two transmitters 7, 8 input surface waves into the surface of the sheet metal strip 10 as measurement signals 11, 12. The surface waves run in the direction 13 along the sheet metal strip 10 up to a receiver 9 which is likewise arranged on the window frame 6. The receiver 9 receives the measurement signals 11, 12. If an object G, for example a body part of a human or of an animal, is placed between the upper edge 14 of the actuation unit 2 and the stop 5 during a closing process, the surface oscillation of the sheet metal strip and thus the transmission characteristic of the measurement signals 11, 12 change if trapping occurs. This change in the transmission characteristic is registered by the evaluation unit 15. The evaluation unit transmits this information to a control unit 16. The control unit 16 generates a control signal which brings about a reversal of the movement of the window pane 2 in the opposite direction to the closing direction 4 at the actuator drive 3, causing the object G to be released. Since this release of the object G takes place quickly, a reliable anti-trapping protection can be ensured.

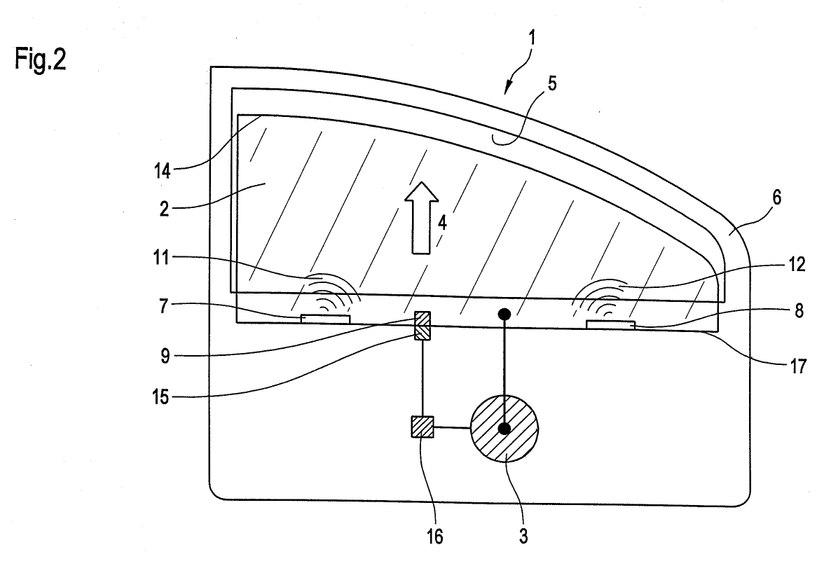

FIG. 2 shows a further car door 1 with an active sensor. The transmitters 7, 8 and the receiver 9 are arranged in the region of the lower edge 16 of the window pane, which is arranged counter to the closing direction 4 and which cannot be seen in the closed position of the window pane. The two transmitters 7, 8 input surface waves into the surface of the window pane as measurement signals 11, 12, and form an oscillation system together with the receiver 9. In the case of trapping, these surface waves are attenuated. As a result, their transmission characteristic changes. This change is received by the receiver 9. The release of the trapped object G takes place in a way analogous to that described in FIG. 1.

Incorporated by reference herein in their entirety are Germany priority application number 20 2006 002 044.6, filed Feb. 9, 2006, and its certified English language translation, copies of both of which documents are filed concurrently herewith.

What is claimed is:

1. An active sensor system comprising:
a transmitter for emitting a measurement signal;
a receiver for receiving the measurement signal;
a transmission link for transmitting the measurement signal; and
an evaluation unit configured to register a change in a transmission characteristic of the measurement signal, and to generate an output signal corresponding to the registered change, wherein the transmitter is configured to emit the measurement signal discontinuously, whereby the transmission power is briefly above a maximum transmission power which is possible during continuous operation and is on average below the maximum transmission power.

2. The system according to claim 1, wherein the transmission link is embodied as a function of an event to be measured.

3. The system according to claim 1, wherein the sensor comprises a tactile sensor.

4. The system according to claim 1, wherein the transmitter is configured to emit the measurement signal periodically at fixed time intervals.

5. The system according to claim 1, wherein the evaluation unit is configured to generate the output signal only when a change in a measured value is above a predefined threshold.

6. The system according to claim 1, wherein the transmitter is configured to emit the measurement signal only on request by the receiver.

7. The system according to claim 1, wherein the transmitter is configured to transmit a plurality of measurement signals simultaneously in a predefined time window.

8. The system according to claim 1, wherein the transmitter is configured to transmit a plurality of measurement signals successively in a predefined time window.

9. The system according to claim 1, wherein the receiver is configured to differentiate a plurality of measurement signals on the basis of transmission characteristics.

10. The system according to claim 1 further comprising at least one further transmitter.

11. The system according to claim 10 further comprising a common receiver in communication with the transmitters.

12. An actuation system comprising:
an actuator element configured to move against a stop;
a drive for driving the actuator element;
a control unit for controlling the drive; and
a sensor system comprising:
a transmitter for emitting a measurement signal;
a receiver for receiving the measurement signal;
a transmission link for transmitting the measurement signal; and
an evaluation unit configured to register a change in a transmission characteristic of the measurement signal, and to generate an output signal corresponding to the registered change, wherein the transmitter is configured to emit the measurement signal discontinuously, whereby the transmission power is briefly above a maximum transmission power which is possible during continuous operation and is on average below the maximum transmission power,
the sensor system connected to the control unit, wherein the control unit is configured to perform at least one of the following of the group consisting of (i) stopping the drive, and (ii) reversing the drive, if a case of trapping is detected.
